(19) United States
(12) Patent Application Publication
(10) Pub. No.: US 2011/0051546 A1
(43) Pub. Date: Mar. 3, 2011

(54) FLUID BLENDING APPARATUS AND PROCESS

(76) Inventors: Steven FINLEY, Wayne, NJ (US); Mario Lopez, Frouzins (FR)

(21) Appl. No.: 12/550,550

(22) Filed: Aug. 31, 2009

(51) Int. Cl. G05D 11/02; B01F 15/02; B01F 13/02

(52) U.S. Cl. 366/106; 366/182.4; 366/152.1; 366/107

(57) ABSTRACT

A process for blending a plurality of fluids utilizes an apparatus including a blending tank having at least one inlet and an outlet; a first supply line and a second supply line in fluid communication with the at least one inlet; the first supply line being in fluid communication with a first fluid source and having a first timing valve disposed between the first fluid source and the at least one inlet; the second supply line being in fluid communication with a second fluid source and having a second timing valve disposed between the second fluid source and the at least one inlet; a controller operatively connected to the first and second timing valves for controlling frequency and duration of actuation of the first and second timing valves.

The present disclosure is directed to an apparatus and process for blending or mixing fluids in a relatively accurate, low cost manner.

Systems for blending or mixing fluids, particularly gases, have conventionally controlled and/or varied the pressure, flow rate (volume), or concentration of the component gases in order to obtain the desired gaseous blend.

In contrast, the present apparatus and process provides the desired percentage concentrations of component fluids in the blend by controlling the time interval during which each component is introduced into a mixing vessel or blending tank at a given pressure and flow rate.

### BRIEF DESCRIPTION OF THE DRAWINGS

The accompanying drawings are included to provide a further understanding of the apparatus and process provided herein and are incorporated in and constitute a part of this specification. The drawings illustrate embodiments of the apparatus and process provided herein and, together with the description, serve to explain the principles described herein but are not intended to limit the specification or any of the claims.

FIG. 1 is a schematic diagram of an embodiment of an apparatus for blending or mixing fluids.

FIG. 2 is a schematic diagram of an alternative embodiment of an apparatus for blending or mixing fluids.

FIG. 3 is a schematic diagram of another embodiment of an apparatus for blending or mixing fluids.

FIG. 4 is a schematic diagram of a further embodiment of an apparatus for blending or mixing fluids.

### DESCRIPTION

In certain embodiments, an apparatus for blending fluids may include a blending tank having at least one inlet and an outlet; the at least one inlet being in fluid communication with at least a first supply line and a second supply line; the first supply line being in fluid communication with a first fluid source and having first timing valve means disposed between the first fluid source and the at least one inlet; the second supply line being in fluid communication with a second fluid source and having second timing valve means disposed between the second fluid source and the at least one inlet; and a controller operatively connected to the first timing valve means and the second timing valve means. In certain embodiments, the first timing valve means may include a first solenoid valve, while the second timing valve means may include a second solenoid valve.

A first flow regulator may be disposed between the first fluid source and the first timing valve means, and a second flow regulator may be disposed between the second fluid source and the second timing valve means.

In some embodiments, an inlet line is in fluid communication with and disposed between the at least one inlet and each of the first supply line and the second supply line. The inlet line may have a back pressure control valve adapted to control the pressure of fluid entering the blending tank. An outlet flow regulator may also be in fluid communication with the outlet, and an on/off valve may be disposed at a blending tank outlet line in fluid communication with and downstream of the outlet flow regulator.

In other embodiments, the subject apparatus may further include a third supply line in fluid communication with a third fluid source and having third timing valve means disposed between the third source and the at least one inlet; the controller being operatively connected to the third timing valve means. A third flow regulator may be disposed between the third fluid source and the third timing valve means.

In certain embodiments, the first fluid source may be adapted to provide gaseous carbon dioxide to the first supply line, and the second fluid source may be adapted to provide gaseous nitrogen to the second supply line.

There is also provided a process for blending a plurality of fluids which includes providing at least a first fluid flow from a first fluid source at a first flow rate and a second fluid flow from a second fluid source at a second flow rate to a blending tank; periodically interrupting the first fluid flow by first timing valve means and the second fluid flow by second timing valve means; and controlling the timing (or frequency) and duration of said interrupting to provide proportions of the first fluid and second fluid to the blending tank for mixing to form a fluid blend. In certain embodiments, the first timing valve means may include a first solenoid valve, and the second timing valve means may include a second solenoid valve.

The process may include regulating the first fluid flow entering the first timing valve means and the second fluid flow entering the second timing valve means.

In certain embodiments, in which the first flow rate and the second flow rate are substantially equal, each of the first fluid flow and the second fluid flow may be directed to a common inlet of the blending tank. The process may further comprise regulating the flow rate of fluid entering or exiting the blending tank.

The process may include releasing the fluid blend from the blending tank to one of operations, storage or venting. The process may therefore include controlling the pressure of the fluid blend exiting the blending tank.

In certain embodiments of the subject process, wherein the first fluid flow is provided in a first supply line, the first timing valve means may be disposed between the first fluid source and the blending tank; and wherein the second fluid flow is provided in a second supply line, the second timing valve means may be disposed between the second fluid source and the blending tank.

In embodiments of the subject process wherein an inlet line is in fluid communication with and disposed between a common inlet of the blending tank and each of the first supply line and the second supply line, the process may optionally include controlling the pressure of fluid entering the blending tank by a back pressure control valve operatively disposed at the inlet line or at a blending tank outlet line.

The subject apparatus and process are suitable for embodiments wherein the fluid is a gas, and the apparatus and process will be described herein with respect to such embodiments wherein the fluid is a gas. However, the subject apparatus and process are also suitable for embodiments wherein the fluid is a liquid. In certain embodiments of the subject process, the first fluid source may be adapted to provide gaseous carbon dioxide, and the second fluid source may be adapted to provide gaseous nitrogen.

The present apparatus and process permits the preparation of proportionally accurate fluid blends or mixtures, where control to parts per million (ppm) levels of components is not critical. For certain types of applications, it is acceptable to create fluid mixtures that can vary from the nominal, accepted set point by a few percent, such as for example 1% to 2% outside the set point range.

The present apparatus and method provide a low-cost, relatively accurate way to produce blends or mixtures of two or more gases including but not limited to air, nitrogen, oxygen, carbon dioxide and/or argon. In one embodiment, the gas blend includes nitrogen and carbon dioxide. Blends or mixtures may be provided ranging from 0% or above to nearly 100% of each component gas. However, typical mixtures are 25% to 30% of one gas, with the balance of the remaining gas being 70%-75%.

For example, sparging of wines with gas to displace oxygen or other harmful gases typically calls for a mixture of 30% carbon dioxide and 70% nitrogen. This mixture varies depending on the purpose. Cylinders with pre-blended gas mixtures are available, however these are costly, and often several cylinders may be required having different proportions of mixture components.

Fluid mixtures such as gas blends produced in accordance with the subject apparatus and process embodiments may additionally be used in wineries for processes such as wine inerting, purging and pressure transfer. As wine contains some level of carbon dioxide, the use of a blend of carbon dioxide and nitrogen for sparging will obtain its beneficial effect while maintaining carbon dioxide content, as contrasted to the use of pure nitrogen which strips carbon dioxide from the wine. Gas blends so produced such as from carbon dioxide and nitrogen may also be used in dispensing beer or other beverages, and preserving food products in modified atmosphere packaging.

The present apparatus and process permits users of gas mixtures to blend the component gases as the mixtures are needed. As mixing is often very difficult for a continuous stream, conventional systems use proportioning valve and flow meters with pressure and temperature compensation. While these may be effective in continuously blending a prescribed mixture accurately, these conventional solutions are costly.

The present apparatus and process use timing valve means, such as but not limited to solenoid valves, to control the flow of gases through a gas blending device, such as a tank or vessel. Achieving the required proportioning of flow is accomplished by time-proportioning the activity of the timing valves. For example, a mixture of 30% carbon dioxide with 70% nitrogen can be approximated by opening the carbon dioxide valve for 30% of the time cycle while the nitrogen valve is opened 70% of the time cycle. The mixture is made by controlling the time interval or duration during which each fluid passes through its respective valve, rather than measuring the pressure and/or volume of the fluid dispensed from the source into the system. It is not necessary to sequence the operation of the valves such that one valve is closed while the other is open. It is possible to open both valves at the same time, although one timing valve may be closed intermittently to reduce the volume of its associated gas in the mixture. For example, one timing valve can remain open, while another timing valve opens and closes in a controlled sequence to adjust the mixture. It is likely that the different densities of the gases to be combined will effect the time ratio mentioned.

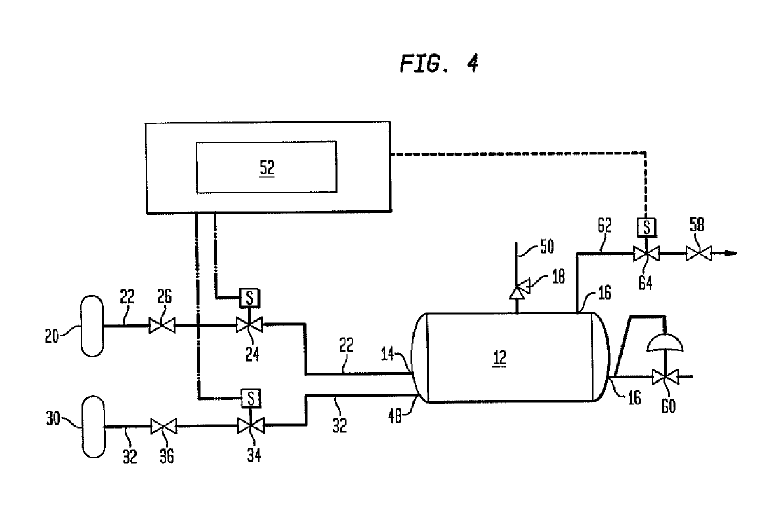

The use of solenoid valves and electronic controls to regulate the cycle permits the use of very short time cycles, for example, 1 second. In the above illustration, the carbon dioxide valve can be opened for 3/10^{ths} of a second, followed by the opening of the nitrogen valve for 7/10^{ths} of a second. This cycle can be repeated continuously while the gas mixture is needed. The gas flowing from each component gas will combine at a “T” connection (excluding the embodiment of FIG. 4), and then proceed to a blending/buffer tank.

The duration of the time cycle of 1 second can be made longer or shorter. Shorter time cycles may shorten the effective life cycle of the solenoids, adding to the maintenance cost of the system. Longer time cycles create less homogeneous mixtures which must be treated with a larger blending/buffer tank.

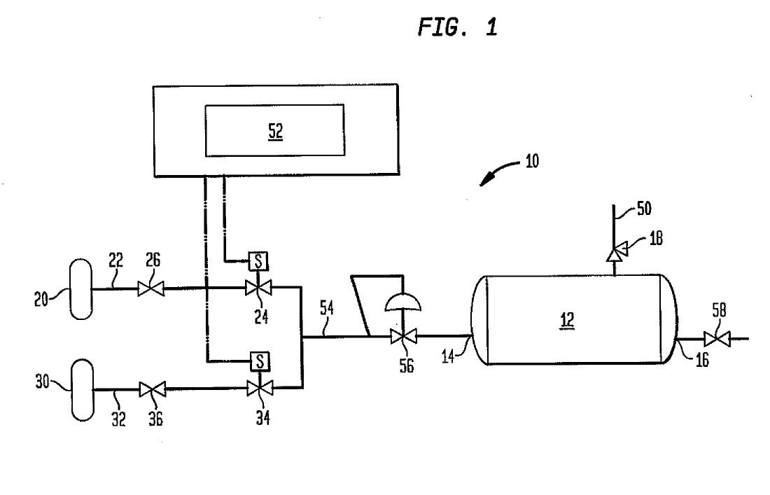

Elements of the embodiments depicted in FIGS. 1-4 which are similar and are designed for use in a similar manner are indicated by similar reference numerals.

Turning to FIG. 1, an embodiment of the fluid blending apparatus 10 includes a mixing vessel or blending tank 12 which can be made of conventional materials for fluid handling devices, such as stainless steel, aluminum, fiber-reinforced composite materials and the like. Blending tank 12 has at least one inlet 14 for receiving the components of the fluid blend, and an outlet 16 for delivering the blended fluid mixture. The blending tank may have a pressure relief valve 18 exhausting to a vent line 50 to protect vessel integrity by relieving excess pressure in the tank 12.

The inlet 14 is in fluid communication with an inlet line 54, which is further in fluid communication with supply lines 22, 32. The supply lines 22, 32 are in fluid communication with and receive a flow of fluid from fluid source 20 and fluid source 30, respectively. The fluid source 20 can be selected from gaseous: carbon dioxide, argon and nitrous oxide, by way of example only. The fluid source 30 can be gaseous nitrogen, by way of example only. Supply lines 22, 32, and inlet line 54 are connected, such as in a “T” joint or connector, remote from the inlet 14. A back-pressure control valve 56 may be disposed at inlet line 54, upstream of inlet 14, to set a common pressure for both fluids flowing through the timing valves 24, 34 and the flow regulating valves 26, 36.

Supply line 22 has timing valve means 24 disposed between fluid source 20 and inlet 14, and similarly supply line 32 has timing valve means 34 disposed between fluid source 30 and inlet 14, each of timing valve means 24, 34 being disposed upstream of the connection of supply lines 22, 32 with inlet line 54. The timing valve means 24, 34 may comprise solenoid valves, that can operate at fast cycle times, such as about 10 millisecond to about 100 seconds, in particular embodiments from about 10 milliseconds to about 10 seconds.

In addition to solenoid valves, the timing valve means 24, 34 may comprise, but are not limited to, other valves that can open and close in the desired time cycle, such as ball valves or butterfly valves. Other valve types operate on a longer time scale than the solenoid valves, and require a larger mixing vessel or blending tank to permit formation of a homogeneous blend for release to operations storage or other processing.

The operation of timing valve means 24, 34 is directed and actuated by controller 52, which may comprise a programmable logic controller, such as those available from Siemens and Allen Bradley. The controller is programmed for the mixture percentages desired, which will in turn determine the time proportioning for the timing valves being opened and closed. An electrical cabinet with timer relay can also be connected to the apparatus 10 to actuate the valves 24, 34 for example.

The timing valve means 24, 34, such as solenoid valves, deliver a certain flow rate of fluid at a given pressure. In order to ensure that the amount of fluid, for example gas, is provided at a set gas volume for each cycle, flow regulators such as flow control valves or orifices may be used to regulate the flow rate. The flow rate through a given orifice or flow control valve setting is sensitive to the pressure and temperature of the gas. By modifying the flow rate by means of an orifice or flow control valve, better control of the amount of fluid introduced can be achieved.

A flow regulator 26 may be disposed at supply line 22 between fluid source 20 and timing valve means 24, and flow regulator 36 may be disposed at supply line 32 between fluid source 30 and timing valve means 34, to control the flow rate of fluid through supply lines 22, 32 to the timing valve means 24, 34. Flow regulators 26, 36 used in the blending apparatus 10 may include, but are not limited to, ball valves, butterfly valves, gate valves, globe valves, needle valves and the like.

The pressure may be maintained at a constant setting utilizing back-pressure control valve 56, which senses pressure upstream, and opens (sensing higher pressure) or closes (sensing lower pressure) to achieve a constant pressure for the timing valve means and the flow regulators. This enables the flow rate to be maintained consistently for any setting of the flow regulators 26, 36.

The fluid blend or mixture may be subject to fluctuations in the relative concentrations of the component fluids, or gases. Since the timing valve means 24, 34 alternate between supplying the different fluids into the system, the composition of the fluid mixture in the inlet line 54 will vary considerably depending on the phase in the time cycle. Also, the flow will be subject to pulsing corresponding to the opening and closing of the timing valves. Following the point where the two fluid streams mix at the junction of the supply lines 22, 32, the blending tank 12 provides a buffering means to create a homogeneous mixture or blend through diffusion within the blending tank, while dampening the pressure pulses.

A flow regulator 58 such as a manual or automated flow control valve may also be in fluid communication with outlet 16, controlling the pressure or flow rate of the fluid blend exiting blending tank 12. The flow regulator 58 may comprise valve types discussed above with respect to flow regulators 26, 36. The fluid blend, such as a gas mixture, may be released continuously or intermittently from the blending tank 12 to manufacturing or processing operations, or alternatively to storage, for example a storage tank or cylinder, or to venting to the ambient or atmosphere if not needed for storage or operations.

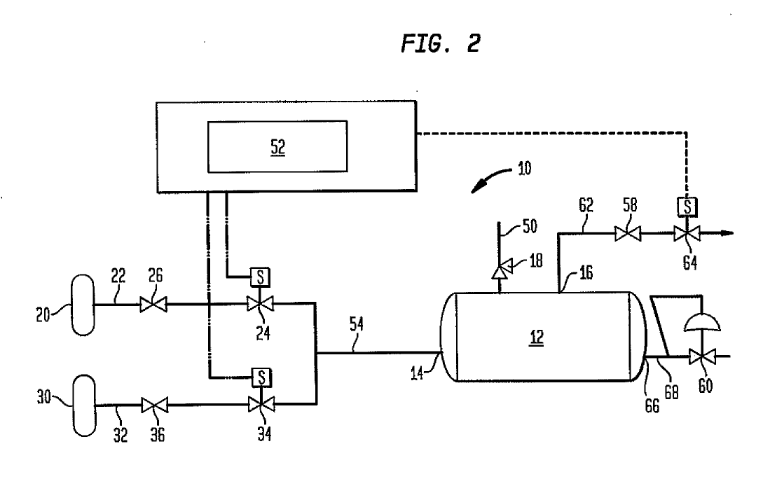

An alternative embodiment is shown in FIG. 2. The pressure of the system, including fluid entering or exiting mixing vessel or blending tank 12, may be controlled by back-pressure control valve 60, disposed in fluid communication with secondary outlet 66 for the blending tank 12 via outlet line 68 which vents excess pressure from the tank 12. The flow rate and/or pressure of blended fluid, released from blending tank 12 through outlet 16 for use in operations or storage may be regulated by flow regulator 58 disposed at outlet line 62. Valve means 64, optionally a solenoid valve, manages the delivery of the blended fluid according to signals or directions from the process controller 52. While valve 60 does control the pressure of the tank 12, valve 60 has a primary function of maintaining a uniform pressure in lines 22, 32 so that when valves 24, 26, 34, 36 are open, regardless of amount, the flow through such valves is predictable to the operator of the system.

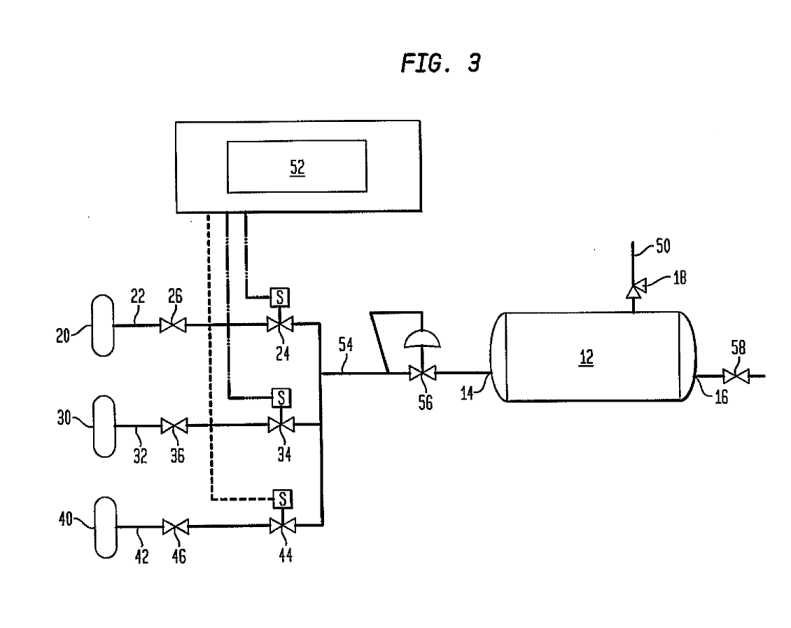

In another embodiment shown in FIG. 3, a third fluid may be provided for mixing or blending in blending tank 12 from third fluid source 40 through third supply line 42, which is in fluid communication with inlet 14 via inlet line 54. The third supply line 42 has timing valve means 44 disposed between fluid source 40 and inlet 14, with timing valve means 44 being disposed upstream of the connection of supply lines 22, 32, 42 with inlet line 54. The operation of timing valve means 44 also may be directed and actuated by controller 52. Of course, the present apparatus and process are not limited to two or three fluids for blending, and additional fluids beyond those discussed may be utilized with corresponding modifications of the apparatus and process according to the disclosure herein.

The embodiments described with respect to FIGS. 1-3 contemplate the pressure and flow rate from first fluid source 20 and second fluid source 30, at least as modulated by flow regulators 26, 36 to be nominally equal.

FIG. 4 shows an embodiment in which different pressure and/or flow rates of the fluids to be mixed or blended can be accommodated. Instead of each supply line converging into a single inlet line, blending tank 12 can have a plurality of inlets, corresponding to the different fluids, different flow rates, and/or different pressures being utilized. For example, supply line 22 has timing valve means 24 disposed between fluid source 20 and inlet 14, while supply line 32 has timing valve means 34 disposed between the fluid source 30 and second inlet 48 of the tank 12. In effect, the inlets 24, 48 are ports into the tank 12 for the lines 22, 32, respectively as shown in FIG. 4.

A flow regulator 26 may be disposed at supply line 22 between fluid source 20 and timing valve means 24, and flow regulator 36 may be disposed at supply line 32 between fluid source 30 and timing valve means 34, to control the flow rate of fluid through supply lines 22, 32 to the timing valve means 24, 34. A back-pressure control valve 60 may be disposed downstream of outlet 16 to control the pressure at the valve means 24, 34 to provide a constant gas density of the fluid entering blending tank 12, hence a more predictable gas flow rate. Alternatively, supply lines 22, 32 can and join downstream of the valves 24, 34 to utilize a common inlet to blending tank 12 in accordance with FIG. 1. The controller 52 is connected to the valve means 64.

### Example

In one example referring to FIG. 1, the required flow from the fluid blending system 10 is 5 NM³/hr (83 liters/min) of a gas mixture consisting of 25% carbon dioxide and 75% nitrogen on a volume basis. To produce this homogeneous composition, the contents from supply line 22, in this example carbon dioxide, is mixed with the contents of supply line 32, in this example nitrogen. The flow rates in each of the lines 22, 32 is adjusted using needle valve 26 and needle valve 36 respectively, and each valve is set to allow at least the full flow requirement of 83 liters/min. To ensure that each of the valves 26, 36 regulates the flow consistently, the back pressure, controlled by back-pressure control valve 56, is set for a pressure of 1 bar gauge (14.4 psig) to regulate the respective densities of the gases in the supply lines 22, 32.

To create the mixture of 25% carbon dioxide and 75% nitrogen by volume, timing valve 24 will open for 25% of the time cycle (T24), while timing valve 34 will open for 75% of the cycle (T34). In this example, timing valve 24 and timing valve 34 are solenoid valves, which are quick-acting valves controlled by an electrical signal from the controller 52. Since valves 24, 34 are quick-acting, the time cycle T can be very short; in this example, T equals one (1) second.

In addition to the time cycle T, there can be an additional adjustable dwell time T_{d} during which both valves 24, 34 are closed; allowing for the gases to mix in the mixing blending tank 12. However, this feature is not required in order to make the fluid blending system functional.

When the system is started, timing valve 24 opens for time cycle T24 of 0.25 seconds (0.004 minutes), allowing 0.004 minutes at 83 liters/minute, or 0.35 liters, of carbon dioxide to flow through to the blending tank 12. After timing valve 24 closes, the timing valve 34 opens for time cycle T34 of 0.75 seconds (0.013 minutes) allowing 1.04 liters of nitrogen to flow through to the blending tank 12. After one cycle, the mixing tank has 1.39 liters of a mixture of 0.35 liters of carbon dioxide and 1.04 liters of nitrogen. The cycles repeat every time cycle T or time cycle plus dwell time T+T_{d}, resulting in a relatively consistent, uniform mixture of gas exiting the blending tank 12 in the same proportions of 25% carbon dioxide and 75% nitrogen. The flow rate of the fluid blend exiting blending tank 12 is regulated using needle valve 58.

In certain embodiments, the capacity of blending tank 12 may be sized to provide adequate storage for a minimum of 10 cycles, although a larger capacity blending tank provides increased ability for the apparatus 10 to adjust to changes in demand for the fluid blend, or gas mixture. In this example, the blending tank 12 would have a capacity of 10 seconds or 0.167 minutes, which is equivalent to a volume of 10×(0.35+1.04) liters, or 13.8 liters. This nominal volume can be reduced by increasing the pressure in the blending tank. The volume required when the gas is under increased pressure can be calculated by dividing the calculated nominal volume, at atmospheric pressure, by the number of atmospheres (1.01 bar). For example, the nominal capacity of blending tank 12 of Example 1 can be divided by 4 atmospheres (4.04 bar), so the volume capacity required for 10 cycles is reduced to 3.4 liters.

The blending tank 12 volume can further be reduced by reducing the time cycle T from 1 second to 0.1 seconds, accomplished by increasing the frequency of the timing valve 24, 34 or solenoid valve, cycles. In the above example, the nominal volume capacity of blending tank 12 can be reduced to 1.38 liters when the time cycle T is 0.1 seconds, then further reduced by increasing the pressure to 4 atmospheres so that the combined effect reduces the volume, first from 13.8 liters to 1.38 liters by accounting for the change in time cycle T, then further to 0.35 liters by accounting for a change in pressure to 4 atmospheres.

It should be understood that in order to increase the pressure in blending tank 12, the pressure setting for pressure control valve 56 must be higher than pressure in the blending tank 12.

The present apparatus and process embodiments permit low-cost preparation of proportionally accurate fluid blends or mixtures, such as blends or mixtures of two or more gases, that vary from the nominal set point by only a few percentages. The use of pressure, temperature and composition analyzers or sensors is not required, although the same may be used with the subject apparatus or process as desired, if only to calibrate initial settings.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. An apparatus for blending fluids, comprising:
a blending tank having at least one inlet and an outlet;
a first supply line for a first fluid and a second supply line for a second fluid, the first and second supply lines in fluid communication with the at least one inlet;
the first supply line being in fluid communication with a first fluid source and having a first timing valve disposed between the first fluid source and the at least one inlet;
the second supply line being in fluid communication with a second fluid source and having a second timing valve disposed between the second fluid source and the at least one inlet;
a controller operatively connected to the first and second timing valves for controlling frequency and duration of the time of actuation for the first and second timing valves to proportion first and second fluid flows for a blended fluid.

2. The apparatus of claim 1, comprising an inlet line in fluid communication with and disposed between the at least one inlet and each of the first supply line and the second supply line, the inlet line optionally having a back pressure control valve adapted to control pressure between the first and second timing valves and the back pressure control valve.

3. The apparatus of claim 1, comprising an inlet line in fluid communication with and disposed between the at least one inlet and each of the first supply line and the second supply line, the inlet line optionally having a back pressure control valve adapted to control pressure in the apparatus downstream from the first and second timing valves.

4. The apparatus of claim 1, comprising a first flow regulator disposed between the first fluid source and the first timing valve, and a second flow regulator disposed between the second fluid source and the second timing valve.

5. The apparatus of claim 1, comprising an outlet flow regulator in fluid communication with the outlet, optionally comprising an outlet valve disposed at a blending tank outlet line in fluid communication with and downstream of the outlet flow regulator.

6. The apparatus of claim 1, wherein the first timing valve comprises a first solenoid valve, and the second timing valve comprises a second solenoid valve.

7. The apparatus of claim 1, further comprising a third supply line in fluid communication with a third fluid source and the at least one inlet, the third supply line having a third timing valve disposed between the third fluid source and the at least one inlet; the controller being operatively connected to the third timing valve.

8. The apparatus of claim 7, comprising a third flow regulator disposed between the third fluid source and the third timing valve.

9. The apparatus of claim 1, wherein the at least one inlet comprises a first port connected to the first supply line and a second port connected to the second supply line.

10. The apparatus of claim 1, wherein the first fluid source is adapted to provide gaseous carbon dioxide to the first supply line.

11. The apparatus of claim 1, wherein the second fluid source is adapted to provide gaseous nitrogen to the second supply line.

12. A process for blending a plurality of fluids, comprising:
providing a first fluid flow at a first flow rate from a first fluid source, and a second fluid flow at a second flow rate from a second fluid source to a blending tank;
periodically interrupting the first fluid flow by a first timing valve and the second fluid flow by a second timing valve;
controlling the frequency and duration of said interrupting to provide proportions of the first fluid and the second fluid to the blending tank for mixing to form a fluid blend.

13. The process of claim 12, further comprising regulating the first fluid flow entering the first timing valve and the second fluid flow entering the second timing valve.

14. The process of claim 13, wherein the first flow rate and the second flow rate are substantially equal and wherein each of the first fluid flow and the second fluid flow are directed to a common inlet of the blending tank.

15. The process of claim 12, further comprising controlling a pressure of the first and second fluids entering the blending tank and a pressure of the fluid blend exiting the blending tank.

16. The process of claim 12, further comprising releasing the fluid blend from the blending tank and regulating a flow rate of the fluid blend exiting the blending tank.

17. The process of claim 12, comprising providing the first fluid flow in a first supply line having the first timing valve disposed between the first fluid source and the blending tank; and providing the second fluid flow in a second supply line having the second timing valve disposed between the second fluid source and the blending tank.

18. The process of claim 17, comprising interposing an inlet line in fluid communication with a common inlet of the blending tank and each of the first supply line and the second supply line; and optionally controlling pressure of the first and second fluid flows entering the blending tank.

19. The process of claim 12, wherein the first and second fluid flows comprise a gas.

20. The process of claim 12, wherein the first fluid source comprises gas selected from the group consisting of carbon dioxide, argon and nitrous oxide.

21. The process of claim 12, wherein the second fluid source provides gaseous nitrogen.

22. The process of claim 12, wherein the first timing valve comprises a first solenoid valve, and the second timing valve comprises a second solenoid valve.
